(19) United States
(12) Patent Application Publication
(10) Pub. No.: US 2021/0173969 A1
(43) Pub. Date: Jun. 10, 2021

(54) MULTIFACTOR ANALYSIS OF BUILDING MICROENVIRONMENTS

(71) Applicant: Johnson Controls Technology Company, Auburn Hills, MI (US)

(72) Inventors: Nelson Abbey, Passage West (IE); Jeremiah Cahill, Cork (IE); Juan Miguel Marino Camarasa, Cork (IE); Adrian Collins, Cork (IE); Ian Hennessy, Blackrock (IE); Matthew Leach, Cork (IE); Roisin O'Brien, Glanmire (IE); Eleanor Alice O'Leary, Cork (IE); Shane O'Sullivan, Cork (IE); James Young, Cork (IE)

(73) Assignee: Johnson Controls Technology Company, Auburn Hills, MI (US)

(21) Appl. No.: 17/111,468

(22) Filed: Dec. 3, 2020

Related U.S. Application Data
(60) Provisional application No. 62/943,521, filed on Dec. 4, 2019.

(51) Int. Cl. G06F 30/13; G06F 30/27; G06F 30/25; G06N 20/00

(52) U.S. Cl. CPC G06F 30/13; G06F 30/27; G06F 2119/08; G06N 20/00; G06F 30/25

(57) ABSTRACT

A method for updating a digital twin of a building, comprising receiving measurements from a plurality of sensors of a portable device at a location within the building, the measurements comprising values of a plurality of environmental conditions at the location of the portable device within the building at a first time; generating a point in the digital twin of the building, the point having virtual coordinates that correspond to the location of the portable device within the building; and training one or more models configured to generate the digital twin of the building based on the received measurements and the point in the digital twin of the building.

### CROSS-REFERENCE TO RELATED APPLICATIONS

The present application claims the benefit of and priority to U.S. Provisional Patent Application 62/943,521, filed Dec. 4, 2019, the entirety of which incorporated herein by reference for all purposes.

### BACKGROUND

The present disclosure relates generally to building management systems. The present disclosure relates more particularly to the collection and processing of information relating to environmental factors within and surrounding a building.

A building management system (BMS) is, in general, a system of devices configured to control, monitor, and manage equipment in or around a building or building area. A BMS can include a heating, ventilation, or air conditioning (HVAC) system, a security system, a lighting system, a fire alerting system, another system that is capable of managing building functions or devices, or any combination thereof. BMS devices may be installed in any environment (e.g., an indoor area or an outdoor area) and the environment may include any number of buildings, spaces, zones, rooms, or areas. A BMS may include METASYS® building controllers or other devices sold by Johnson Controls, Inc., as well as building devices and components from other sources.

A BMS may include one or more computer systems (e.g., servers, BMS controllers, etc.) that serve as enterprise level controllers, application or data servers, head nodes, master controllers, or field controllers for the BMS. Such computer systems may communicate with multiple downstream building systems or subsystems (e.g., an HVAC system, a security system, etc.) according to like or disparate protocols (e.g., LON, BACnet, etc.). The computer systems may also provide one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with the BMS, its subsystems, and devices.

Environmental conditions, such as heating and ventilation, and lighting are typically controlled uniformly across large office spaces, for example, open plan offices. This method ignores microenvironments that are created by non-homogenous layouts. For example, the proximity of some office space to a window, or the proximity of desks to air ventilation diffusers.

Modern buildings, such as offices, typically feature a large number of environmental sensors, which feed back to the control system as to the conditions within the controlled environment. However, at any given point where environmental readings are taken, only a small number of environmental conditions are likely to be monitored. For example, there may be separate devices to monitor temperature for HVAC control and ambient light levels for lighting control. When these devices are placed at different locations within a space, it can be difficult to accurately infer correlations between the two. For example, it can be difficult to determine whether additional heating is caused by strong direct sunlight.

Many sensors can only sense their immediate environment, and so current building management systems have several limitations. Sensors are most frequently located only on the walls or ceiling of a space. The environmental conditions at different points within a large space, such as an open plan office, may be significantly different to those conditions sensed around the edges. In some installations, the sensors may be located above a suspended ceiling or within the HVAC equipment, and so are further isolated from the conditions within the space.

### SUMMARY

One implementation of the present disclosure is a method for updating a digital representation of a building. The method may include receiving, by one or more processors, measurements from a plurality of sensors of a portable device at a location within the building, the measurements comprising values of a plurality of environmental conditions at the location of the portable device within the building at a first time; generating, by the one or more processors, a point in the digital twin of the building, the point having virtual coordinates that correspond to the location of the portable device within the building; and training, by the one or more processors, one or more models configured to generate the digital twin of the building based on the received measurements and the point in the digital twin of the building.

In some embodiments, the measurements are first measurements, the location is a first location, the point is a first point, and the values are first values. The method may further comprise receiving, by the one or more processors, second measurements from the plurality of sensors of the portable device at a second location within the building, the second measurements comprising second values of the plurality of environmental conditions at the second location at a second time; generating, by the one or more processors, a second point in the digital twin of the building, the second point having virtual coordinates that correspond to the second location of the portable device within the building; and training, by the one or more processors, the one or more models based on the received second measurements and the second point.

In some embodiments, the building is a first building, the method may further comprise generating, by the one or more processors, a digital representation of a second building using the one or more models.

In some embodiments, the building is a first building, the method may further comprise comparing, by the one or more processors, a design of the first building with a plurality of designs of second buildings; identifying, by the one or more processors, a design of a second building with a similarity score with the design of the first building that exceeds a threshold; and responsive to identifying the design of the second building with a similarity score that exceeds the threshold, generating, by the one or more processors, a digital twin of the second building using the one or more models.

In some embodiments, the method may further comprise adding, by the one or more processors, a representation of a piece of building equipment to the digital twin of the building; and predicting, by the one or more processors using the one or more models, environmental effects of the addition of the piece of building equipment to the building.

In some embodiments, the point is first point, the method may further comprise generating, by the one or more processors, digital twins of subspaces within the building using the one or more models, wherein the location is within a subspace of the building; generating, by the one or more processors, a second point in a digital twin of the subspace, the second point having virtual coordinates that correspond to the location of the portable device within the subspace; and training, by the one or more processors, the one or more models based on the received measurements and the second point.

In some embodiments, the method may further comprise predicting, by the one or more processors using the one or more models, whether the environmental conditions are likely to cause patient discomfort.

In some embodiments, the method may further comprise receiving, by the one or more processors, data from sensors associated with heating, ventilation, and air conditioning system of the building at the first time; and training, by the one or more processors, the one or more models based on the received data.

In some embodiments, the method may further comprise training, by the one or more processors, the one or more models according to a supervised learning algorithm based on user feedback received within a time interval of the first time.

Another implementation of the present disclosure is a system for updating a digital representation of a building comprising one or more memory devices configured to store instructions thereon that, when executed by one or more processors, cause the one or more processors to receive measurements from a plurality of sensors of a portable device at a location within the building, the measurements comprising values of a plurality of environmental conditions at the location of the portable device within the building at a first time; generate a point in the digital twin of the building, the point having virtual coordinates that correspond to the location of the portable device within the building; and train one or more models configured to generate the digital twin of the building based on the received measurements and the point in the digital twin of the building.

In some embodiments, the measurements are first measurements, the location is a first location, the point is a first point, and the values are first values. The instructions may further cause the one or more processors to receive second measurements from the plurality of sensors of the portable device at a second location within the building, the second measurements comprising second values of the plurality of environmental conditions at the second location at a second time; generate a second point in the digital twin of the building, the second point having virtual coordinates that correspond to the second location of the portable device within the building; and train the one or more models based on the received second measurements and the second point.

In some embodiments, the building is a first building, the instructions may further cause the one or more processors to generate a digital representation of a second building using the one or more models.

In some embodiments, the portable device comprises a housing and wherein the plurality of sensors are connected to the housing as a sensor array.

In some embodiments, the instructions further cause the one or more processors to add a representation of a piece of building equipment into the digital representation of the building; and predict, using the one or more models, environmental effects of the addition of the piece of building equipment to the building.

In some embodiments, the instructions further cause the one or more processors to train the one or more models according to a supervised learning algorithm based on user feedback indicating a level of comfort of a user received within a time interval of the first time.

In some embodiments, the instructions further cause the one or more processors to receive a first measurement from the plurality of sensors of the portable device at a first location within the building, the first measurement comprising first values of the plurality of environmental conditions at the first location at a second time; generate a first point in the digital representation of the building, the first point having virtual coordinates that correspond to the first location of the portable device within the building; and train the one or more models based on the received first measurement.

In some embodiments, the instructions further cause the one or more processors to compare a design of the building with a plurality of designs of first buildings; identify a design of a first building with a similarity score with the design of the building that exceeds a threshold; and responsive to identifying the design of the first building with a similarity score that exceeds the threshold, generate a digital representation of the first building using the one or more models.

In some embodiments, the portable device comprises a housing and wherein the plurality of sensors are connected to the housing as a sensor array.

In some embodiments, the instructions further cause the one or more processors to add a representation of a piece of building equipment into the digital representation of the building; and predict, using the one or more models, environmental effects of the addition of the piece of building equipment to the building.

In some embodiments, the instructions further cause the one or more processors to train the one or more models according to a supervised learning algorithm based on user feedback indicating a level of comfort of a user received within a time interval of the first time.

Yet another implementation of the present disclosure is a method for analyzing environmental data of a building, comprising receiving, by one or more processors, measurements from a plurality of sensors of a portable device at a location within the building, the measurements comprising values of a plurality of environmental conditions at the location of the portable device within the building at a first time; receiving, by the one or more processors, an indication of a comfort level of a user located within the building; responsive to the indication of the comfort level being associated with a time within a time interval of the first time, correlating, by the one or more processors, with the indication of the comfort level of the user; and training, by the one or more processors, one or more models configured to generate a digital representation of the building based on the correlation between the measurements and the indication of the comfort level of the user.

In some embodiments, the portable device is configured to receive the indication of the comfort level of the user via a user input on a display of the portable device.

In some embodiments, the method further comprises receiving, by the one or more processors, a list of environmental factors that are associated with the received indication of the comfort level of the user, the list indicating whether the each factor of the list is positive or negative, wherein training the one or models is further based on the list of environmental factors.

In some embodiments, the method further comprises receiving, by the one or more processors, productivity data associated with the user; and correlating, by the one or more processors, the productivity data with the measurements, wherein training the one or models is further based on the correlated productivity data.

In some embodiments, the method further comprises adjusting, by the one or more processors, the environmental controls within the building in response to receiving measurement data collected by the portable device at a second time based on an output by the trained one or more models.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a building management system (BMS), according to some embodiments.

FIG. 2 is a block diagram of a BMS that serves the building of FIG. 1, according to some embodiments.

FIG. 3 is a block diagram of a BMS controller which can be used in the BMS of FIG. 2, according to some embodiments.

FIG. 4 is another block diagram of the BMS that serves the building of FIG. 1, according to some embodiments.

FIG. 5 is a block diagram of a system architecture for a sensor array, according to some embodiments.

FIG. 6 is a drawing of an office environment that shows an example use of the sensor array of FIG. 5, according to some embodiments.

FIG. 7 is a cross-sectional drawing of a building and a representation of a corresponding digital twin, according to some embodiments.

FIG. 8 is a block diagram for the lifecycle of a building and the potential uses of a digital twin, according to some embodiments.

FIG. 9 is a flow diagram of a process for updating a digital representation of a building, according to some embodiments.

FIG. 10 is a flow diagram of a process for analyzing environmental data of a building, according to some embodiments.

### DETAILED DESCRIPTION

### Overview

Referring generally to the FIGURES, a method of multifactor analysis of building spaces that uses an array of environmental sensors to identify and characterize microenvironments, which can be combined with occupant feedback and used to inform the creation of a digital twin of a building is shown, according to some embodiments.

One implementation of the present disclosure is a method of multifactor analysis of an open office workspace that uses an array of environmental sensors on a single device to identify and characterize microenvironments within that space. This sensor array may be IP enabled, portable, self-contained, can communicate data wirelessly, and can be battery powered. These characteristics may enable the sensor array to be placed in any location within spaces and to provide accurate, comprehensive, environmental data about specific locations within the building.

The environmental data can be further enhanced by combining it with feedback from users about their perceived levels of comfort. This perception of comfort can vary considerably from what may typically be inferred from environmental readings. For example, the temperature in a space may be measured at 69 degrees Fahrenheit, and so judged to be ideal, but an individual's comfort may be affected by a multitude of other factors, including airflow, lighting, noise, the type of work that they are engaged in, and their physiology. The characteristics of the sensor array enable it to be placed in close proximity (e.g., within a threshold or predetermined distance) to an occupant's workspace or an occupant, which may ensure that the sensor data is an accurate representation of the conditions that the occupant is experiencing.

The combined environmental and occupant feedback data can provide an individual, such as a facilities manager, with information about issues within a building. The data can also be incorporated into a BMS for display or to influence the control of HVAC or other systems. The data can also be incorporated into a digital twin of the physical building, to provide insights into the building's operation, improve simulations of the dynamics of the building, or for other purposes.

Advantageously, the combination of multiple sensor types may be incorporated into a single unit, which may be portable and communicate wirelessly, can be placed in a building occupant's work environment, or any location where the collection of environmental data is advantageous. This facilitates highly accurate, multifactor sensor information that relates to specific locations, to be provided to a BMS, digital twin, or other digital representation, for the purpose of enhancing the operation of that representation.

### Building and Building Management System

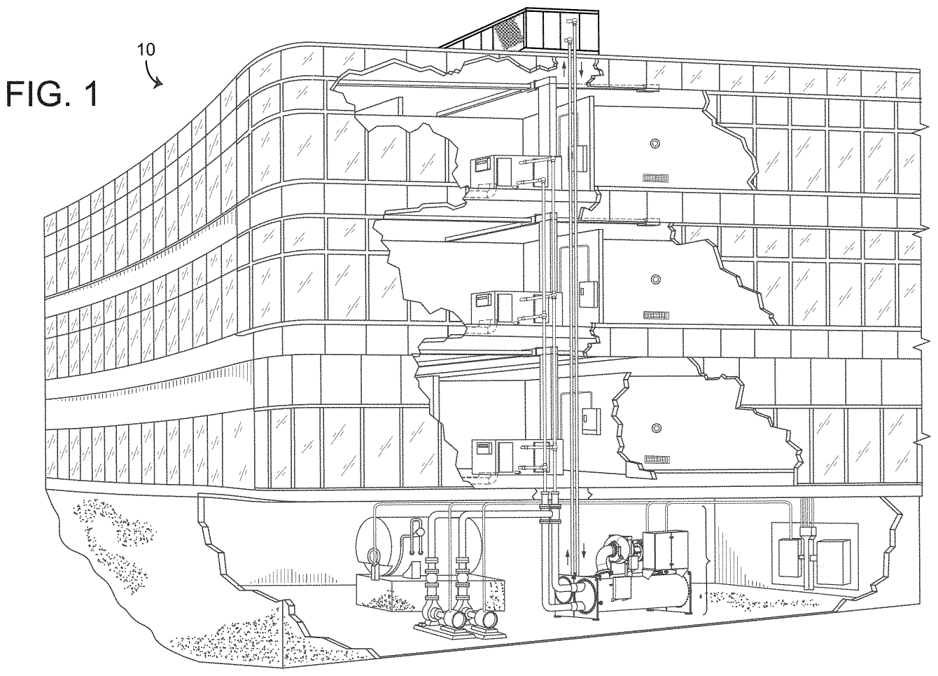

Referring now to FIG. 1, a perspective view of a building 10 is shown, according to some embodiments. A BMS serves building 10. The BMS for building 10 may include any number or type of devices that serve building 10. For example, each floor may include one or more security devices, video surveillance cameras, fire detectors, smoke detectors, lighting systems, HVAC systems, or other building systems or devices. In modern BMSs, BMS devices can exist on different networks within the building (e.g., one or more wireless networks, one or more wired networks, etc.) and yet serve the same building space or control loop. For example, BMS devices may be connected to different communications networks or field controllers even if the devices serve the same area (e.g., floor, conference room, building zone, tenant area, etc.) or purpose (e.g., security, ventilation, cooling, heating, etc.).

BMS devices may collectively or individually be referred to as building equipment. Building equipment may include any number or type of BMS devices within or around building 10. For example, building equipment may include controllers, chillers, rooftop units, fire and security systems, elevator systems, thermostats, lighting, serviceable equipment (e.g., vending machines), and/or any other type of equipment that can be used to control, automate, or otherwise contribute to an environment, state, or condition of building 10. The terms “BMS devices,” “BMS device” and “building equipment” are used interchangeably throughout this disclosure.

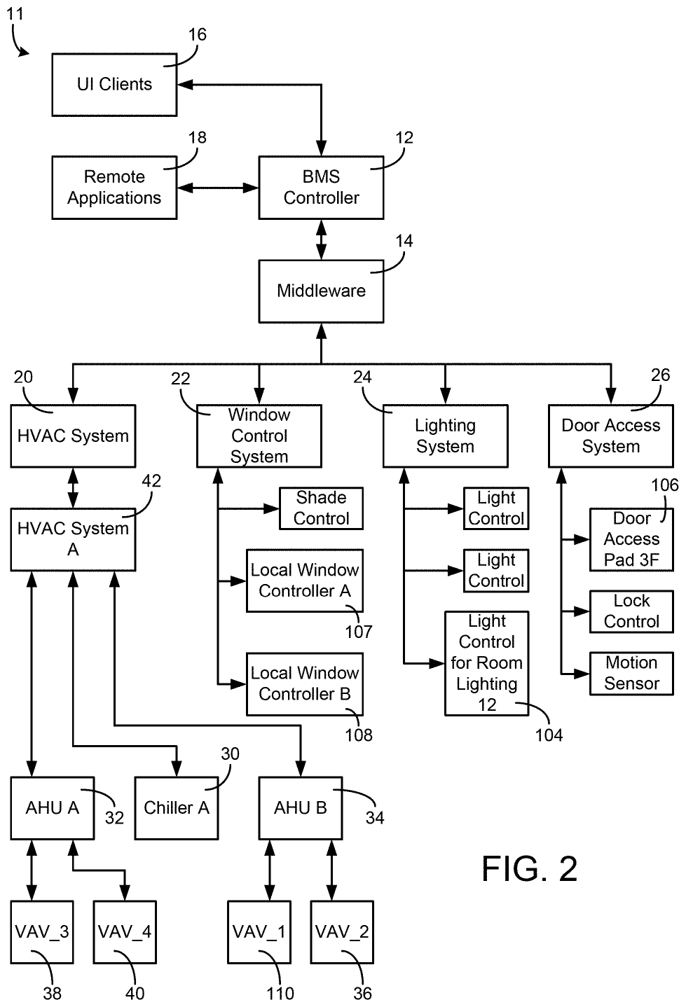

Referring now to FIG. 2, a block diagram of a BMS 11 for building 10 is shown, according to some embodiments. BMS 11 is shown to include a plurality of BMS subsystems 20-26. Each BMS subsystem 20-26 is connected to a plurality of BMS devices and makes data points for varying connected devices available to upstream BMS controller 12. Additionally, BMS subsystems 20-26 may encompass other lower-level subsystems. For example, an HVAC system may be broken down further as “HVAC system A,” “HVAC system B,” etc. In some buildings, multiple HVAC systems or subsystems may exist in parallel and may not be a part of the same HVAC system 20.

As shown in FIG. 2, BMS 11 may include an HVAC system 20. HVAC system 20 may control HVAC operations building 10. HVAC system 20 is shown to include a lower-level HVAC system 42 (named “HVAC system A”). HVAC system 42 may control HVAC operations for a specific floor or zone of building 10. HVAC system 42 may be connected to air handling units (AHUs) 32, 34 (named “AHU A” and “AHU B,” respectively, in BMS 11). AHU 32 may serve variable air volume (VAV) boxes 38, 40 (named “VAV_3” and “VAV_4” in BMS 11). Likewise, AHU 34 may serve VAV boxes 36 and 110 (named “VAV_2” and “VAV_1”). HVAC system 42 may also include chiller 30 (named “Chiller A” in BMS 11). Chiller 30 may provide chilled fluid to AHU 32 and/or to AHU 34. HVAC system 42 may receive data (i.e., BMS inputs such as temperature sensor readings, damper positions, temperature setpoints, etc.) from AHUs 32, 34. HVAC system 42 may provide such BMS inputs to HVAC system 20 and on to middleware 14 and BMS controller 12. Similarly, other BMS subsystems may receive inputs from other building devices or objects and provide the received inputs to BMS controller 12 (e.g., via middleware 14).

Middleware 14 may include services that allow interoperable communication to, from, or between disparate BMS subsystems 20-26 of BMS 11 (e.g., HVAC systems from different manufacturers, HVAC systems that communicate according to different protocols, security/fire systems, IT resources, door access systems, etc.). Middleware 14 may be, for example, an EnNet server sold by Johnson Controls, Inc. While middleware 14 is shown as separate from BMS controller 12, middleware 14 and BMS controller 12 may integrated in some embodiments. For example, middleware 14 may be a part of BMS controller 12.

Still referring to FIG. 2, window control system 22 may receive shade control information from one or more shade controls, ambient light level information from one or more light sensors, and/or other BMS inputs (e.g., sensor information, setpoint information, current state information, etc.) from downstream devices. Window control system 22 may include window controllers 107, 108 (e.g., named “local window controller A” and “local window controller B,” respectively, in BMS 11). Window controllers 107, 108 control the operation of subsets of window control system 22. For example, window controller 108 may control window blind or shade operations for a given room, floor, or building in the BMS.

Lighting system 24 may receive lighting related information from a plurality of downstream light controls (e.g., from room lighting 104). Door access system 26 may receive lock control, motion, state, or other door related information from a plurality of downstream door controls. Door access system 26 is shown to include door access pad 106 (named “Door Access Pad 3F”), which may grant or deny access to a building space (e.g., a floor, a conference room, an office, etc.) based on whether valid user credentials are scanned or entered (e.g., via a keypad, via a badge-scanning pad, etc.).

BMS subsystems 20-26 may be connected to BMS controller 12 via middleware 14 and may be configured to provide BMS controller 12 with BMS inputs from various BMS subsystems 20-26 and their varying downstream devices. BMS controller 12 may be configured to make differences in building subsystems transparent at the human-machine interface or client interface level (e.g., for connected or hosted user interface (UI) clients 16, remote applications 18, etc.). BMS controller 12 may be configured to describe or model different building devices and building subsystems using common or unified objects (e.g., software objects stored in memory) to help provide the transparency. Software equipment objects may allow developers to write applications capable of monitoring and/or controlling various types of building equipment regardless of equipment-specific variations (e.g., equipment model, equipment manufacturer, equipment version, etc.). Software building objects may allow developers to write applications capable of monitoring and/or controlling building zones on a zone-by-zone level regardless of the building subsystem makeup.

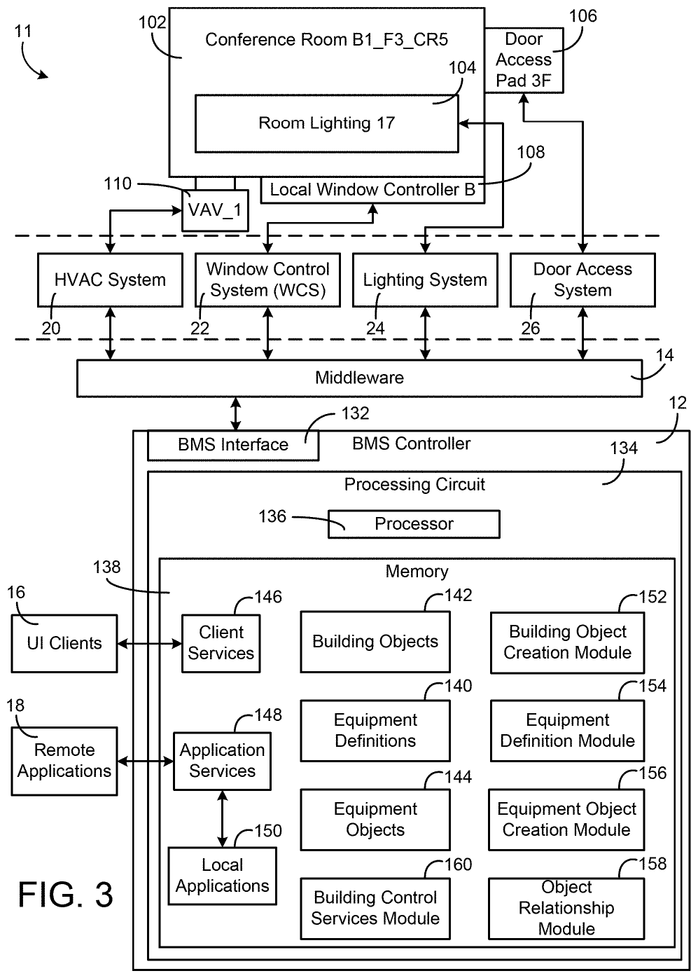

Referring now to FIG. 3, a block diagram illustrating a portion of BMS 11 in greater detail is shown, according to some embodiments. Particularly, FIG. 3 illustrates a portion of BMS 11 that services a conference room 102 of building 10 (named “B1_F3_CR5”). Conference room 102 may be affected by many different building devices connected to many different BMS subsystems. For example, conference room 102 includes or is otherwise affected by VAV box 110, window controller 108 (e.g., a blind controller), a system of lights 104 (named “Room Lighting 17”), and a door access pad 106.

Each of the building devices shown at the top of FIG. 3 may include local control circuitry configured to provide signals to their supervisory controllers or more generally to the BMS subsystems 20-26. The local control circuitry of the building devices shown at the top of FIG. 3 may also be configured to receive and respond to control signals, commands, setpoints, or other data from their supervisory controllers. For example, the local control circuitry of VAV box 110 may include circuitry that affects an actuator in response to control signals received from a field controller that is a part of HVAC system 20. Window controller 108 may include circuitry that affects windows or blinds in response to control signals received from a field controller that is part of window control system (WCS) 22. Room lighting 104 may include circuitry that affects the lighting in response to control signals received from a field controller that is part of lighting system 24. Access pad 106 may include circuitry that affects door access (e.g., locking or unlocking the door) in response to control signals received from a field controller that is part of door access system 26.

Still referring to FIG. 3, BMS controller 12 is shown to include a BMS interface 132 in communication with middleware 14. In some embodiments, BMS interface 132 is a communications interface. For example, BMS interface 132 may include wired or wireless interfaces (e.g., jacks, antennas, transmitters, receivers, transceivers, wire terminals, etc.) for conducting data communications with various systems, devices, or networks. BMS interface 132 can include an Ethernet card and port for sending and receiving data via an Ethernet-based communications network. In another example, BMS interface 132 includes a Wi-Fi transceiver for communicating via a wireless communications network. BMS interface 132 may be configured to communicate via local area networks or wide area networks (e.g., the Internet, a building WAN, etc.).

In some embodiments, BMS interface 132 and/or middleware 14 includes an application gateway configured to receive input from applications running on client devices. For example, BMS interface 132 and/or middleware 14 may include one or more wireless transceivers (e.g., a Wi-Fi transceiver, a Bluetooth transceiver, a NFC transceiver, a cellular transceiver, etc.) for communicating with client devices. BMS interface 132 may be configured to receive building management inputs from middleware 14 or directly from one or more BMS subsystems 20-26. BMS interface 132 and/or middleware 14 can include any number of software buffers, queues, listeners, filters, translators, or other communications-supporting services.

Still referring to FIG. 3, BMS controller 12 is shown to include a processing circuit 134 including a processor 136 and memory 138. Processor 136 may be a general purpose or specific purpose processor, an application specific integrated circuit (ASIC), one or more field programmable gate arrays (FPGAs), a group of processing components, or other suitable processing components. Processor 136 is configured to execute computer code or instructions stored in memory 138 or received from other computer readable media (e.g., CDROM, network storage, a remote server, etc.).

Memory 138 may include one or more devices (e.g., memory units, memory devices, storage devices, etc.) for storing data and/or computer code for completing and/or facilitating the various processes described in the present disclosure. Memory 138 may include random access memory (RAM), read-only memory (ROM), hard drive storage, temporary storage, non-volatile memory, flash memory, optical memory, or any other suitable memory for storing software objects and/or computer instructions. Memory 138 may include database components, object code components, script components, or any other type of information structure for supporting the various activities and information structures described in the present disclosure. Memory 138 may be communicably connected to processor 136 via processing circuit 134 and may include computer code for executing (e.g., by processor 136) one or more processes described herein. When processor 136 executes instructions stored in memory 138 for completing the various activities described herein, processor 136 generally configures BMS controller 12 (and more particularly processing circuit 134) to complete such activities.

Still referring to FIG. 3, memory 138 is shown to include building objects 142. In some embodiments, BMS controller 12 uses building objects 142 to group otherwise ungrouped or unassociated devices so that the group may be addressed or handled by applications together and in a consistent manner (e.g., a single user interface for controlling all of the BMS devices that affect a particular building zone or room). Building objects can apply to spaces of any granularity. For example, a building object can represent an entire building, a floor of a building, or individual rooms on each floor. In some embodiments, BMS controller 12 creates and/or stores a building object in memory 138 for each zone or room of building 10. Building objects 142 can be accessed by UI clients 16 and remote applications 18 to provide a comprehensive user interface for controlling and/or viewing information for a particular building zone. Building objects 142 may be created by building object creation module 152 and associated with equipment objects by object relationship module 158, described in greater detail below.

Still referring to FIG. 3, memory 138 is shown to include equipment definitions 140. Equipment definitions 140 stores the equipment definitions for various types of building equipment. Each equipment definition may apply to building equipment of a different type. For example, equipment definitions 140 may include different equipment definitions for variable air volume modular assemblies (VMAs), fan coil units, air handling units (AHUs), lighting fixtures, water pumps, and/or other types of building equipment.

Equipment definitions 140 define the types of data points that are generally associated with various types of building equipment. For example, an equipment definition for VMA may specify data point types such as room temperature, damper position, supply air flow, and/or other types data measured or used by the VMA. Equipment definitions 140 allow for the abstraction (e.g., generalization, normalization, broadening, etc.) of equipment data from a specific BMS device so that the equipment data can be applied to a room or space.

Each of equipment definitions 140 may include one or more point definitions. Each point definition may define a data point of a particular type and may include search criteria for automatically discovering and/or identifying data points that satisfy the point definition. An equipment definition can be applied to multiple pieces of building equipment of the same general type (e.g., multiple different VMA controllers). When an equipment definition is applied to a BMS device, the search criteria specified by the point definitions can be used to automatically identify data points provided by the BMS device that satisfy each point definition.

In some embodiments, equipment definitions 140 define data point types as generalized types of data without regard to the model, manufacturer, vendor, or other differences between building equipment of the same general type. The generalized data points defined by equipment definitions 140 allows each equipment definition to be referenced by or applied to multiple different variants of the same type of building equipment.

In some embodiments, equipment definitions 140 facilitate the presentation of data points in a consistent and user-friendly manner. For example, each equipment definition may define one or more data points that are displayed via a user interface. The displayed data points may be a subset of the data points defined by the equipment definition.

In some embodiments, equipment definitions 140 specify a system type (e.g., HVAC, lighting, security, fire, etc.), a system sub-type (e.g., terminal units, air handlers, central plants), and/or data category (e.g., critical, diagnostic, operational) associated with the building equipment defined by each equipment definition. Specifying such attributes of building equipment at the equipment definition level allows the attributes to be applied to the building equipment along with the equipment definition when the building equipment is initially defined. Building equipment can be filtered by various attributes provided in the equipment definition to facilitate the reporting and management of equipment data from multiple building systems.

Equipment definitions 140 can be automatically created by abstracting the data points provided by archetypal controllers (e.g., typical or representative controllers) for various types of building equipment. In some embodiments, equipment definitions 140 are created by equipment definition module 154, described in greater detail below.

Still referring to FIG. 3, memory 138 is shown to include equipment objects 144. Equipment objects 144 may be software objects that define a mapping between a data point type (e.g., supply air temperature, room temperature, damper position) and an actual data point (e.g., a measured or calculated value for the corresponding data point type) for various pieces of building equipment. Equipment objects 144 may facilitate the presentation of equipment-specific data points in an intuitive and user-friendly manner by associating each data point with an attribute identifying the corresponding data point type. The mapping provided by equipment objects 144 may be used to associate a particular data value measured or calculated by BMS 11 with an attribute that can be displayed via a user interface.

Equipment objects 144 can be created (e.g., by equipment object creation module 156) by referencing equipment definitions 140. For example, an equipment object can be created by applying an equipment definition to the data points provided by a BMS device. The search criteria included in an equipment definition can be used to identify data points of the building equipment that satisfy the point definitions. A data point that satisfies a point definition can be mapped to an attribute of the equipment object corresponding to the point definition.

Each equipment object may include one or more attributes defined by the point definitions of the equipment definition used to create the equipment object. For example, an equipment definition which defines the attributes “Occupied Command,” “Room Temperature,” and “Damper Position” may result in an equipment object being created with the same attributes. The search criteria provided by the equipment definition are used to identify and map data points associated with a particular BMS device to the attributes of the equipment object. The creation of equipment objects is described in greater detail below with reference to equipment object creation module 156.

Equipment objects 144 may be related with each other and/or with building objects 142. Causal relationships can be established between equipment objects to link equipment objects to each other. For example, a causal relationship can be established between a VMA and an AHU which provides airflow to the VMA. Causal relationships can also be established between equipment objects 144 and building objects 142. For example, equipment objects 144 can be associated with building objects 142 representing particular rooms or zones to indicate that the equipment object serves that room or zone. Relationships between objects are described in greater detail below with reference to object relationship module 158.

Still referring to FIG. 3, memory 138 is shown to include client services 146 and application services 148. Client services 146 may be configured to facilitate interaction and/or communication between BMS controller 12 and various internal or external clients or applications. For example, client services 146 may include web services or application programming interfaces available for communication by UI clients 16 and remote applications 18 (e.g., applications running on a mobile device, energy monitoring applications, applications allowing a user to monitor the performance of the BMS, automated fault detection and diagnostics systems, etc.). Application services 148 may facilitate direct or indirect communications between remote applications 18, local applications 150, and BMS controller 12. For example, application services 148 may allow BMS controller 12 to communicate (e.g., over a communications network) with remote applications 18 running on mobile devices and/or with other BMS controllers.

In some embodiments, application services 148 facilitate an applications gateway for conducting electronic data communications with UI clients 16 and/or remote applications 18. For example, application services 148 may be configured to receive communications from mobile devices and/or BMS devices. Client services 146 may provide client devices with a graphical user interface that consumes data points and/or display data defined by equipment definitions 140 and mapped by equipment objects 144.

Still referring to FIG. 3, memory 138 is shown to include a building object creation module 152. Building object creation module 152 may be configured to create the building objects stored in building objects 142. Building object creation module 152 may create a software building object for various spaces within building 10. Building object creation module 152 can create a building object for a space of any size or granularity. For example, building object creation module 152 can create a building object representing an entire building, a floor of a building, or individual rooms on each floor. In some embodiments, building object creation module 152 creates and/or stores a building object in memory 138 for each zone or room of building 10.

The building objects created by building object creation module 152 can be accessed by UI clients 16 and remote applications 18 to provide a comprehensive user interface for controlling and/or viewing information for a particular building zone. Building objects 142 can group otherwise ungrouped or unassociated devices so that the group may be addressed or handled by applications together and in a consistent manner (e.g., a single user interface for controlling all of the BMS devices that affect a particular building zone or room). In some embodiments, building object creation module 152 uses the systems and methods described in U.S. patent application Ser. No. 12/887,390, filed Sep. 21, 2010, for creating software defined building objects.

In some embodiments, building object creation module 152 provides a user interface for guiding a user through a process of creating building objects. For example, building object creation module 152 may provide a user interface to client devices (e.g., via client services 146) that allows a new space to be defined. In some embodiments, building object creation module 152 defines spaces hierarchically. For example, the user interface for creating building objects may prompt a user to create a space for a building, for floors within the building, and/or for rooms or zones within each floor.

In some embodiments, building object creation module 152 creates building objects automatically or semi-automatically. For example, building object creation module 152 may automatically define and create building objects using data imported from another data source (e.g., user view folders, a table, a spreadsheet, etc.). In some embodiments, building object creation module 152 references an existing hierarchy for BMS 11 to define the spaces within building 10. For example, BMS 11 may provide a listing of controllers for building 10 (e.g., as part of a network of data points) that have the physical location (e.g., room name) of the controller in the name of the controller itself. Building object creation module 152 may extract room names from the names of BMS controllers defined in the network of data points and create building objects for each extracted room. Building objects may be stored in building objects 142.

Still referring to FIG. 3, memory 138 is shown to include an equipment definition module 154. Equipment definition module 154 may be configured to create equipment definitions for various types of building equipment and to store the equipment definitions in equipment definitions 140. In some embodiments, equipment definition module 154 creates equipment definitions by abstracting the data points provided by archetypal controllers (e.g., typical or representative controllers) for various types of building equipment. For example, equipment definition module 154 may receive a user selection of an archetypal controller via a user interface. The archetypal controller may be specified as a user input or selected automatically by equipment definition module 154. In some embodiments, equipment definition module 154 selects an archetypal controller for building equipment associated with a terminal unit such as a VMA.

Equipment definition module 154 may identify one or more data points associated with the archetypal controller. Identifying one or more data points associated with the archetypal controller may include accessing a network of data points provided by BMS 11. The network of data points may be a hierarchical representation of data points that are measured, calculated, or otherwise obtained by various BMS devices. BMS devices may be represented in the network of data points as nodes of the hierarchical representation with associated data points depending from each BMS device. Equipment definition module 154 may find the node corresponding to the archetypal controller in the network of data points and identify one or more data points which depend from the archetypal controller node.

Equipment definition module 154 may generate a point definition for each identified data point of the archetypal controller. Each point definition may include an abstraction of the corresponding data point that is applicable to multiple different controllers for the same type of building equipment. For example, an archetypal controller for a particular VMA (i.e., “VMA-20”) may be associated an equipment-specific data point such as “VMA-20.DPR-POS” (i.e., the damper position of VMA-20) and/or “VMA-20.SUP-FLOW” (i.e., the supply air flow rate through VMA-20). Equipment definition module 154 abstract the equipment-specific data points to generate abstracted data point types that are generally applicable to other equipment of the same type. For example, equipment definition module 154 may abstract the equipment-specific data point “VMA-20.DPR-POS” to generate the abstracted data point type “DPR-POS” and may abstract the equipment-specific data point “VMA-20.SUP-FLOW” to generate the abstracted data point type “SUP-FLOW.” Advantageously, the abstracted data point types generated by equipment definition module 154 can be applied to multiple different variants of the same type of building equipment (e.g., VMAs from different manufacturers, VMAs having different models or output data formats, etc.).

In some embodiments, equipment definition module 154 generates a user-friendly label for each point definition. The user-friendly label may be a plain text description of the variable defined by the point definition. For example, equipment definition module 154 may generate the label “Supply Air Flow” for the point definition corresponding to the abstracted data point type “SUP-FLOW” to indicate that the data point represents a supply air flow rate through the VMA. The labels generated by equipment definition module 154 may be displayed in conjunction with data values from BMS devices as part of a user-friendly interface.

In some embodiments, equipment definition module 154 generates search criteria for each point definition. The search criteria may include one or more parameters for identifying another data point (e.g., a data point associated with another controller of BMS 11 for the same type of building equipment) that represents the same variable as the point definition. Search criteria may include, for example, an instance number of the data point, a network address of the data point, and/or a network point type of the data point.

In some embodiments, search criteria include a text string abstracted from a data point associated with the archetypal controller. For example, equipment definition module 154 may generate the abstracted text string “SUP-FLOW” from the equipment-specific data point “VMA-20.SUP-FLOW.” Advantageously, the abstracted text string matches other equipment-specific data points corresponding to the supply air flow rates of other BMS devices (e.g., “VMA-18.SUP-FLOW,” “SUP-FLOW.VMA-01,” etc.). Equipment definition module 154 may store a name, label, and/or search criteria for each point definition in memory 138.

Equipment definition module 154 may use the generated point definitions to create an equipment definition for a particular type of building equipment (e.g., the same type of building equipment associated with the archetypal controller). The equipment definition may include one or more of the generated point definitions. Each point definition defines a potential attribute of BMS devices of the particular type and provides search criteria for identifying the attribute among other data points provided by such BMS devices.

In some embodiments, the equipment definition created by equipment definition module 154 includes an indication of display data for BMS devices that reference the equipment definition. Display data may define one or more data points of the BMS device that will be displayed via a user interface. In some embodiments, display data are user defined. For example, equipment definition module 154 may prompt a user to select one or more of the point definitions included in the equipment definition to be represented in the display data. Display data may include the user-friendly label (e.g., “Damper Position”) and/or short name (e.g., “DPR-POS”) associated with the selected point definitions.

In some embodiments, equipment definition module 154 provides a visualization of the equipment definition via a graphical user interface. The visualization of the equipment definition may include a point definition portion which displays the generated point definitions, a user input portion configured to receive a user selection of one or more of the point definitions displayed in the point definition portion, and/or a display data portion which includes an indication of an abstracted data point corresponding to each of the point definitions selected via the user input portion. The visualization of the equipment definition can be used to add, remove, or change point definitions and/or display data associated with the equipment definitions.

Equipment definition module 154 may generate an equipment definition for each different type of building equipment in BMS 11 (e.g., VMAs, chillers, AHUs, etc.). Equipment definition module 154 may store the equipment definitions in a data storage device (e.g., memory 138, equipment definitions 140, an external or remote data storage device, etc.).

Still referring to FIG. 3, memory 138 is shown to include an equipment object creation module 156. Equipment object creation module 156 may be configured to create equipment objects for various BMS devices. In some embodiments, equipment object creation module 156 creates an equipment object by applying an equipment definition to the data points provided by a BMS device. For example, equipment object creation module 156 may receive an equipment definition created by equipment definition module 154. Receiving an equipment definition may include loading or retrieving the equipment definition from a data storage device.

In some embodiments, equipment object creation module 156 determines which of a plurality of equipment definitions to retrieve based on the type of BMS device used to create the equipment object. For example, if the BMS device is a VMA, equipment object creation module 156 may retrieve the equipment definition for VMAs; whereas if the BMS device is a chiller, equipment object creation module 156 may retrieve the equipment definition for chillers. The type of BMS device to which an equipment definition applies may be stored as an attribute of the equipment definition. Equipment object creation module 156 may identify the type of BMS device being used to create the equipment object and retrieve the corresponding equipment definition from the data storage device.

In other embodiments, equipment object creation module 156 receives an equipment definition prior to selecting a BMS device. Equipment object creation module 156 may identify a BMS device of BMS 11 to which the equipment definition applies. For example, equipment object creation module 156 may identify a BMS device that is of the same type of building equipment as the archetypal BMS device used to generate the equipment definition. In various embodiments, the BMS device used to generate the equipment object may be selected automatically (e.g., by equipment object creation module 156), manually (e.g., by a user) or semi-automatically (e.g., by a user in response to an automated prompt from equipment object creation module 156).

In some embodiments, equipment object creation module 156 creates an equipment discovery table based on the equipment definition. For example, equipment object creation module 156 may create an equipment discovery table having attributes (e.g., columns) corresponding to the variables defined by the equipment definition (e.g., a damper position attribute, a supply air flow rate attribute, etc.). Each column of the equipment discovery table may correspond to a point definition of the equipment definition. The equipment discovery table may have columns that are categorically defined (e.g., representing defined variables) but not yet mapped to any particular data points.

Equipment object creation module 156 may use the equipment definition to automatically identify one or more data points of the selected BMS device to map to the columns of the equipment discovery table. Equipment object creation module 156 may search for data points of the BMS device that satisfy one or more of the point definitions included in the equipment definition. In some embodiments, equipment object creation module 156 extracts a search criterion from each point definition of the equipment definition. Equipment object creation module 156 may access a data point network of the building automation system to identify one or more data points associated with the selected BMS device. Equipment object creation module 156 may use the extracted search criterion to determine which of the identified data points satisfy one or more of the point definitions.

In some embodiments, equipment object creation module 156 automatically maps (e.g., links, associates, relates, etc.) the identified data points of selected BMS device to the equipment discovery table. A data point of the selected BMS device may be mapped to a column of the equipment discovery table in response to a determination by equipment object creation module 156 that the data point satisfies the point definition (e.g., the search criteria) used to generate the column. For example, if a data point of the selected BMS device has the name “VMA-18.SUP-FLOW” and a search criterion is the text string “SUP-FLOW,” equipment object creation module 156 may determine that the search criterion is met. Accordingly, equipment object creation module 156 may map the data point of the selected BMS device to the corresponding column of the equipment discovery table.

Advantageously, equipment object creation module 156 may create multiple equipment objects and map data points to attributes of the created equipment objects in an automated fashion (e.g., without human intervention, with minimal human intervention, etc.). The search criteria provided by the equipment definition facilitates the automatic discovery and identification of data points for a plurality of equipment object attributes. Equipment object creation module 156 may label each attribute of the created equipment objects with a device-independent label derived from the equipment definition used to create the equipment object. The equipment objects created by equipment object creation module 156 can be viewed (e.g., via a user interface) and/or interpreted by data consumers in a consistent and intuitive manner regardless of device-specific differences between BMS devices of the same general type. The equipment objects created by equipment object creation module 156 may be stored in equipment objects 144.

Still referring to FIG. 3, memory 138 is shown to include an object relationship module 158. Object relationship module 158 may be configured to establish relationships between equipment objects 144. In some embodiments, object relationship module 158 establishes causal relationships between equipment objects 144 based on the ability of one BMS device to affect another BMS device. For example, object relationship module 158 may establish a causal relationship between a terminal unit (e.g., a VMA) and an upstream unit (e.g., an AHU, a chiller, etc.) which affects an input provided to the terminal unit (e.g., air flow rate, air temperature, etc.).

Object relationship module 158 may establish relationships between equipment objects 144 and building objects 142 (e.g., spaces). For example, object relationship module 158 may associate equipment objects 144 with building objects 142 representing particular rooms or zones to indicate that the equipment object serves that room or zone. In some embodiments, object relationship module 158 provides a user interface through which a user can define relationships between equipment objects 144 and building objects 142. For example, a user can assign relationships in a “drag and drop” fashion by dragging and dropping a building object and/or an equipment object into a “serving” cell of an equipment object provided via the user interface to indicate that the BMS device represented by the equipment object serves a particular space or BMS device.

Still referring to FIG. 3, memory 138 is shown to include a building control services module 160. Building control services module 160 may be configured to automatically control BMS 11 and the various subsystems thereof. Building control services module 160 may utilize closed loop control, feedback control, PI control, model predictive control, or any other type of automated building control methodology to control the environment (e.g., a variable state or condition) within building 10.

Building control services module 160 may receive inputs from sensory devices (e.g., temperature sensors, pressure sensors, flow rate sensors, humidity sensors, electric current sensors, cameras, radio frequency sensors, microphones, etc.), user input devices (e.g., computer terminals, client devices, user devices, etc.) or other data input devices via BMS interface 132. Building control services module 160 may apply the various inputs to a building energy use model and/or a control algorithm to determine an output for one or more building control devices (e.g., dampers, air handling units, chillers, boilers, fans, pumps, etc.) in order to affect a variable state or condition within building 10 (e.g., zone temperature, humidity, air flow rate, etc.).

In some embodiments, building control services module 160 is configured to control the environment of building 10 on a zone-individualized level. For example, building control services module 160 may control the environment of two or more different building zones using different setpoints, different constraints, different control methodology, and/or different control parameters. Building control services module 160 may operate BMS 11 to maintain building conditions (e.g., temperature, humidity, air quality, etc.) within a setpoint range, to optimize energy performance (e.g., to minimize energy consumption, to minimize energy cost, etc.), and/or to satisfy any constraint or combination of constraints as may be desirable for various implementations.

In some embodiments, building control services module 160 uses the location of various BMS devices to translate an input received from a building system into an output or control signal for the building system. Building control services module 160 may receive location information for BMS devices and automatically set or recommend control parameters for the BMS devices based on the locations of the BMS devices. For example, building control services module 160 may automatically set a flow rate setpoint for a VAV box based on the size of the building zone in which the VAV box is located.

Building control services module 160 may determine which of a plurality of sensors to use in conjunction with a feedback control loop based on the locations of the sensors within building 10. For example, building control services module 160 may use a signal from a temperature sensor located in a building zone as a feedback signal for controlling the temperature of the building zone in which the temperature sensor is located.

In some embodiments, building control services module 160 automatically generates control algorithms for a controller or a building zone based on the location of the zone in the building 10. For example, building control services module 160 may be configured to predict a change in demand resulting from sunlight entering through windows based on the orientation of the building and the locations of the building zones (e.g., east-facing, west-facing, perimeter zones, interior zones, etc.).

Building control services module 160 may use zone location information and interactions between adjacent building zones (rather than considering each zone as an isolated system) to more efficiently control the temperature and/or airflow within building 10. For control loops that are conducted at a larger scale (i.e., floor level) building control services module 160 may use the location of each building zone and/or BMS device to coordinate control functionality between building zones. For example, building control services module 160 may consider heat exchange and/or air exchange between adjacent building zones as a factor in determining an output control signal for the building zones.

In some embodiments, building control services module 160 is configured to optimize the energy efficiency of building 10 using the locations of various BMS devices and the control parameters associated therewith. Building control services module 160 may be configured to achieve control setpoints using building equipment with a relatively lower energy cost (e.g., by causing airflow between connected building zones) in order to reduce the loading on building equipment with a relatively higher energy cost (e.g., chillers and roof top units). For example, building control services module 160 may be configured to move warmer air from higher elevation zones to lower elevation zones by establishing pressure gradients between connected building zones.

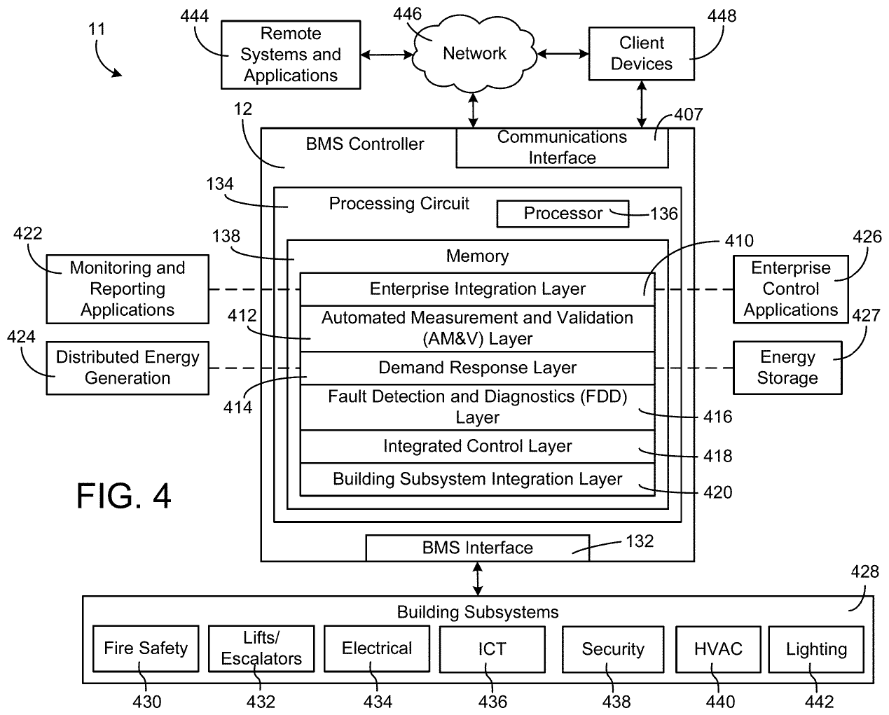

Referring now to FIG. 4, another block diagram illustrating a portion of BMS 11 in greater detail is shown, according to some embodiments. BMS 11 can be implemented in building 10 to automatically monitor and control various building functions. BMS 11 is shown to include BMS controller 12 and a plurality of building subsystems 428. Building subsystems 428 are shown to include a building electrical subsystem 434, an information communication technology (ICT) subsystem 436, a security subsystem 438, an HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10.

Each of building subsystems 428 can include any number of devices, controllers, and connections for completing its individual functions and control activities. HVAC subsystem 440 can include many of the same components as HVAC system 20, as described with reference to FIGS. 2-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BMS controller 12 is shown to include a communications interface 407 and a BMS interface 132. Interface 407 may facilitate communications between BMS controller 12 and external applications (e.g., monitoring and reporting applications 422, enterprise control applications 426, remote systems and applications 444, applications residing on client devices 448, etc.) for allowing user control, monitoring, and adjustment to BMS controller 12 and/or subsystems 428. Interface 407 may also facilitate communications between BMS controller 12 and client devices 448. BMS interface 132 may facilitate communications between BMS controller 12 and building subsystems 428 (e.g., HVAC, lighting security, lifts, power distribution, business, etc.).

Interfaces 407, 132 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 132 can be direct (e.g., local wired or wireless communications) or via a communications network 446 (e.g., a WAN, the Internet, a cellular network, etc.). For example, interfaces 407, 132 can include an Ethernet card and port for sending and receiving data via an Ethernet-based communications link or network. In another example, interfaces 407, 132 can include a Wi-Fi transceiver for communicating via a wireless communications network. In another example, one or both of interfaces 407, 132 can include cellular or mobile phone communications transceivers. In one embodiment, communications interface 407 is a power line communications interface and BMS interface 132 is an Ethernet interface. In other embodiments, both communications interface 407 and BMS interface 132 are Ethernet interfaces or are the same Ethernet interface.

Still referring to FIG. 4, BMS controller 12 is shown to include a processing circuit 134 including a processor 136 and memory 138. Processing circuit 134 can be communicably connected to BMS interface 132 and/or communications interface 407 such that processing circuit 134 and the various components thereof can send and receive data via interfaces 407, 132. Processor 136 can be implemented as a general purpose processor, an application specific integrated circuit (ASIC), one or more field programmable gate arrays (FPGAs), a group of processing components, or other suitable electronic processing components.

Memory 138 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 138 can be or include volatile memory or non-volatile memory. Memory 138 can include database components, object code components, script components, or any other type of information structure for supporting the various activities and information structures described in the present application. According to some embodiments, memory 138 is communicably connected to processor 136 via processing circuit 134 and includes computer code for executing (e.g., by processing circuit 134 and/or processor 136) one or more processes described herein.

In some embodiments, BMS controller 12 is implemented within a single computer (e.g., one server, one housing, etc.). In various other embodiments BMS controller 12 can be distributed across multiple servers or computers (e.g., that can exist in distributed locations). Further, while FIG. 4 shows applications 422 and 426 as existing outside of BMS controller 12, in some embodiments, applications 422 and 426 can be hosted within BMS controller 12 (e.g., within memory 138).

Still referring to FIG. 4, memory 138 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 11.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 12. In yet other embodiments, enterprise control applications 426 can work with layers 410-420 to optimize building performance (e.g., efficiency, energy use, comfort, or safety) based on inputs received at interface 407 and/or BMS interface 132.

Building subsystem integration layer 420 can be configured to manage communications between BMS controller 12 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translates communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427, or from other sources. Demand response layer 414 may receive inputs from other layers of BMS controller 12 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML, files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 11 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Digital Twin

A “digital twin” may be a digital equivalent of a physical object or system, which represents the characteristics of the physical version as accurately as possible through incorporating sensor and other data. Devices within the physical environment may feature sensors that quantify some physical characteristic of that environment. Devices may also have additional information associated with them, such as their current internal state or configuration settings. The information may relate to the current point in time, a record of a historical point in time, or a prediction of a future point in time.

The physical devices may communicate their individual information to a data repository, such as local or cloud-based servers. Each device may have an equivalent digital twin, which may be a digital representation of the device's information within the data repository. Devices may provide a continuous stream of live data to update their respective digital twins, or may periodically send updates on a unified or individual schedule. The combined representation of digital twins for the devices within, for example, a building, may create a digital twin that represents the building as a whole.

In some embodiments, the representation of the digital twins may include the ability to simulate the dynamics of the real-world environment. This may include simulating a device's physical response to operation, such as heating through friction or material fatigue. This may also include simulating the environmental space between devices, such as airflow within a building. In some embodiments, the models that are used to simulate the digital twins are modified when the simulated predictions do not match the information provided by the physical counterparts.

In some embodiments, machine learning techniques are applied to the digital twins to refine the simulations, identify patterns of normal and anomalous behavior, predict the future failure of equipment, or for other purposes.

### Multifactor Analysis of Office Microenvironments

The systems and methods described herein provide for a system and device that includes a portable, Internet Protocol (IP) connected, sensor array that can measure micro-environmental effects. In some embodiments, the device includes a housing to which the sensor array is attached and/or a display. The housing may be any material (e.g., plastic, wood, metal, etc.) and any shape. The sensors of the sensor array may be attached within and/or outside of the housing. The sensor array can measure multiple environmental factors, for example, temperature, humidity, airflow, particulates, carbon dioxide (CO₂), volatile organic compounds (VOC), light temperature, light intensity, and sound. The sensor array can be powered using a self-contained battery or using a power outlet and can connect to a wireless network.

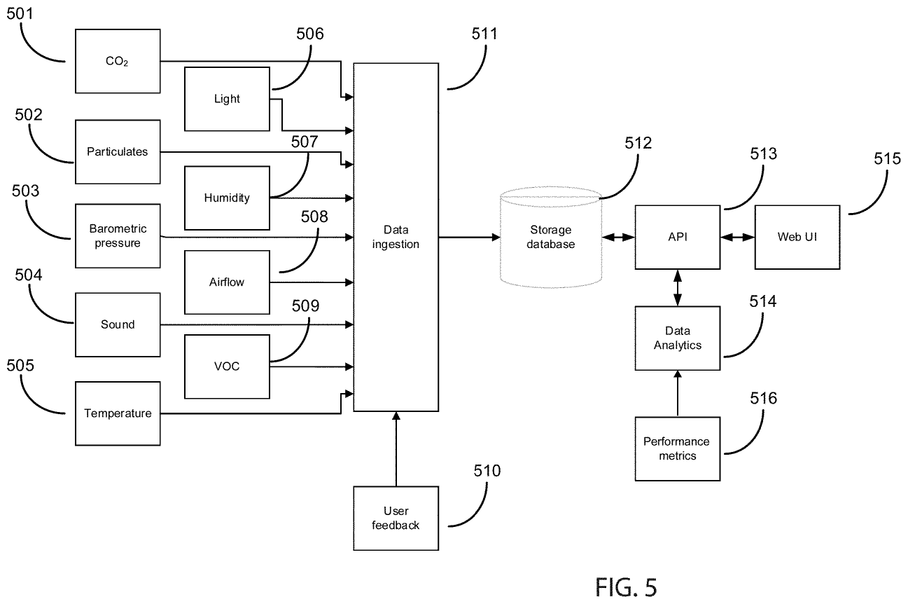

Referring now to FIG. 5, an architecture diagram of a system including a sensor array and a central storage database 512 is shown, according to some embodiments. The components of the systems may be or be similar to corresponding components of BMS 11. The system may operate in the BMS 11. Data may be ingested 511 from a number of sensors sensing CO₂ 501, air particulates 502, barometric pressure 503, sound level 504, temperature 505, light level 506, humidity 507, airflow 508, and VOC 509. The ingested data may be transmitted across a network to a central storage database 512, which may be stored in BMS controller 12 or another device (e.g., a cloud server).

In some embodiments, a data analytics engine 514 may be or include instructions configured to cause a processor (e.g. processor 136 of, BMS controller 12) to use an application programming interface (API) 513 to create metrics 516, and to derive insights from the data. This data may be captured over a prolonged time period. The facility manager may use a web-based UI that visualizes the data 515. The facility manager can periodically access the UI remotely, make adjustments to the BMS, and receive real-time feedback from the building occupants. In some embodiments, the sensor data from the sensor array can provide input for the BMS, which can automatically adjust environmental controls in response.

In some embodiments, a sensor array is assigned to an individual and placed within their working environment. For some building configurations, such as large open-plan offices, the sensor readings from the sensor array may provide an improved representation of the individual's working environment when compared to sensors placed in the ceiling or on the walls. The sensor readings may identify a microenvironment that exists within the larger space. The data analytics engine may use the combination of sensor readings to identify the cause of the microenvironment. For example, higher levels of light and temperature may be caused by sunlight warming a space, while low temperatures and high airflow may indicate that the individual's microenvironment is in close proximity to an HVAC vent.

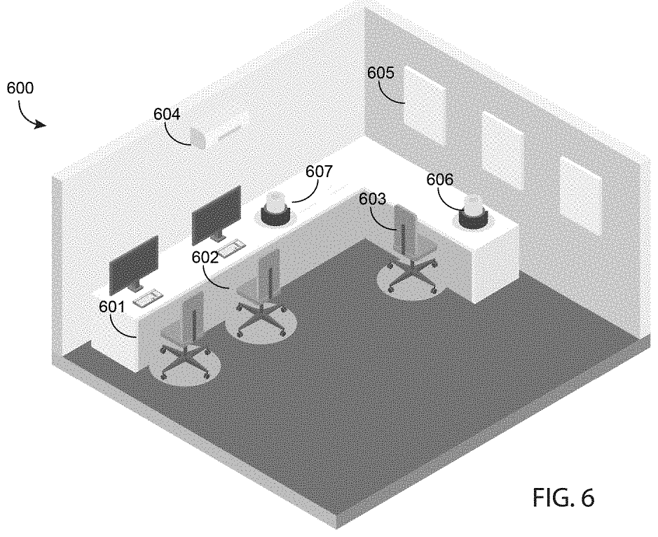

Referring now to FIG. 6, an example application is shown. An office space 600 may contain three different work stations 601, 602, and 603. The environmental conditions of the space may be controlled through a single ventilation system 604 that also contains the primary temperature sensor. Each work station may be influenced by different local environmental factors (proximity to the ventilation system 604 and proximity to windows 605). Sensor arrays may be located at occupant's work stations 606 and 607 to detect and characterize the micro-climate conditions within this space.

In some embodiments, the sensor arrays are part of a system that takes feedback from users. The feedback may take the form of timestamped user feedback data 510 that indicates which factor is causing discomfort. User feedback can be captured on the sensor array (e.g., via a user input on a user interface displayed on a display of the device to which the sensor array is attached) or using an application through a computer or mobile computing device. In situations in which the user feedback is captured on the sensor array, the system can determine that the user feedback is related to the environment close to the sensor array because providing such feedback requires the user to be proximate to the array. For example, the system may identify the sensor array from which it receives feedback and identify an identifier of the sensor array within the system and/or the microenvironment to which it corresponds.

An individual's perception of their discomfort (or comfort) may be matched with the corresponding sensor readings taken at that time (e.g., data analytic engine 514 may identify the timestamp associated with the user feedback and identify sensor data from the sensor array that is associated with timestamps within a threshold or time interval of the user feedback timestamp). The system can update the models associated with the microenvironment based on the user feedback (e.g., train machine learning models that generate the digital twin of the building via a supervised training method based on the taken environmental measurement associated with timestamps within a threshold or time interval of the user feedback and the feedback itself).

In some embodiments, the sensor array is part of a system that monitors factors that relate to the productivity of individuals. For example, the amount of time that an individual spends at their desk could be determined by an occupancy sensor in the sensor array, or by other sensors placed in the environment. Data analytics engine 514 may cross-reference key performance indicators or other productivity metrics 516 with corresponding historical sensor data (e.g., historical occupancy data). A machine learning model (e.g., a machine learning model of the models that generate the digital twin) may be trained to predict the environment conditions in which the occupants are most productive based on the cross-referenced data (e.g., the historical data may be labeled with the corresponding productivity and fed into the machine learning model for training to predict conditions in which the occupants had desirable productivity levels). The assessment of this data can identify the environmental conditions under which individuals are most productive. Consequently, when the data analytics engine 514 receives data indicating the individuals are in the environment, data analytics engine 514 may generate a flag or setting that causes BMS controller 12 to adjust the configurations of building equipment that controls the environment conditions of the area to produce the predicted conditions.

The captured data can be utilized in a number of ways beyond simple monitoring. The data is enriched by occupant tagging. This enriched, microenvironment, multi-variable data can be used to train machine learning algorithms that can predict discomfort events and pre-emptively alert a facilities manager or a BMS.

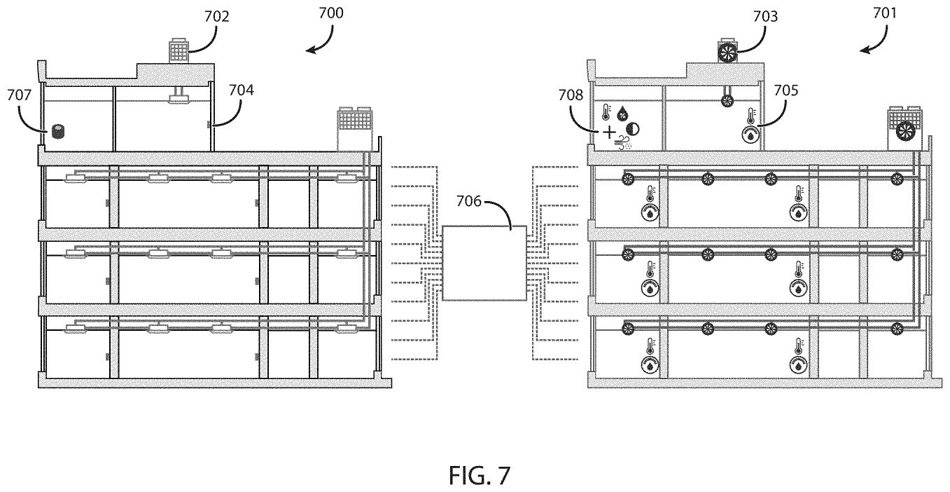

The enriched data can also be used to create a digital twin of a space (or subspace) or to enhance the accuracy of an existing digital twin. For example, referring now to FIG. 7, a representation of a digital twin of a physical building is shown, according to some embodiments. Within a physical building 700, sensing devices, such as thermostats 704, may communicate their sensor data through some embodiment of network infrastructure 706, and may update an equivalent representation 705 within the digital twin 701. Equipment, such as indoor and outdoor units in an HVAC system 702, may also communicate information about their operation, such as fan speed 703. To provide additional environmental data for the digital twin, one or more sensor arrays are placed within a physical space 707, which may then communicate the sensor readings from that location to the digital twin. Each sensor array may create a virtual point within the digital twin, to which multiple types of sensor data are associated 708. This additional data can be used to refine simulations and models of the environment.

In some embodiments, after a sensor array has been at a location for a set period of time, and the accuracy of the model of that environment has been improved, the sensor array can be moved to another location. The virtual representation of the sensor array can continue to exist within the digital twin, and the model of the environment can continue to make predictions based on the historical data recorded at that point in space. In some embodiments, the influence of the virtual representation may degrade over time (e.g., the historical data may grow stale and not accurately represent the corresponding physical environment), but may be reinforced by returning the physical sensor array to the same location (e.g., new sensor data may be used to train or refine the models that generate and/or update the digital twin 701).

In some embodiments, a facility manager or other user marks the location of the sensor arrays on a digital floor plan or other digital representation of a BMS. In other embodiments, the sensor arrays are self-mapping through some method. For example, the sensor arrays may determine their relative locations from each other through the timing of radio signals for triangulation, and then determine their absolute location through reference to a known, fixed-location point in the environment. The location information is retained in the central database or transmitted along with the sensor data, which associates the sensor data with a physical location.

In some embodiments, the location in which to place a sensor array is determined by one of the building's occupants. For example, the occupant may raise a complaint about the environmental conditions in their workspace. If the occupant's report of the conditions is not reflected in the sensor readings of the larger zone within which the workspace is located, the sensor array can be placed within the occupant's workspace to quantify the microenvironment. In some embodiments, the location in which to place a sensor array is determined by the facility manager or other individual who is knowledgeable about the location of existing sensors and factors that affect the environmental conditions, such as the distribution of HVAC equipment or areas heated by direct sunlight. Sensor arrays may be placed where there is a gap in sensor coverage. In some embodiments, the location in which to place a sensor array is determined by the machine learning system or statistical model, with the aim of providing additional data for locations of ambiguity. For example, if the application of physics-based modeling consistently produces simulated results that are significantly different to sensed results, the system could highlight surrounding areas at points where additional data is needed in order to refine the model.

In some embodiments, sensor arrays can be installed in the environment surrounding a building. For example, on the roof, on the exterior skin of the building, in the car park, or on the perimeter wall. Sensor data collected from these sensor arrays provide additional contextual information for the BAS, or an expanded digital twin that incorporates the environment that surrounds a building. The contextual information could include weather conditions or levels of pollutants, which can provide inputs into the logic that controls the HVAC system and determines the proportion of outside air to bring into the building.

In some embodiments, sensor arrays can be installed inside HVAC air ducting or in other components of the HVAC air system. The physical form of the sensor array may be tailored to the environment that it is placed in. For example, a form factor with a low profile may be used to minimize air resistance and prevent the sensor array from obstructing airflow in the system. The sensor arrays can provide data at intermediary points between the locations where sensor readings are typically taken, for example, at the air handling unit and VAV controller. The sensor arrays can also provide data from a wider variety of sensor types than are typically installed.

Sensor data streamed from a sensor array may be applied to a physical environmental simulation space. This would be an enclosed space that one or more individuals could occupy, and where there are internal environmental conditions can be controlled to a high degree of precision. The environmental factors that can be controlled would correspond to sensors in the sensor array. For example, the ability to control the air temperature, intensity, and temperature of the lighting, humidity, and sound-levels. The sound presented within the simulation space may be a live stream of audio from the sensor array, or may be an unrelated audio source that is adjusted in pitch and intensity to represent the audio sensed by the sensor array. An individual could select a currently deployed sensor array, or other location within the digital twin, and experience the environmental conditions at that location. The simulation system would feed back to occupants as to when the environmental conditions are being adjusted, and when the environmental conditions match the selected location.

The digital twin, machine learning algorithm, or equivalent system can identify spaces within a building that are not suitable for their currently designated use, or where microenvironments make parts of a space unsuitable. In these situations, a digital twin can be used to simulate the effect of changes to the environment. For example, simulated HVAC equipment (e.g., a digital representation of HVAC equipment including characteristics (e.g., equipment type, model, energy consumption, size, etc.) of the respective equipment) could be added, removed, or moved within the digital twin, and their effect on the removal or rebalancing of microenvironments may be simulated. Data indicating the addition, movement, or removal of a simulated device may be fed into the models that generate the digital twin. The models may predict the environmental data that would be generated based on such changes and output the data to a user interface for an administrator to view.

In some embodiments, the existence of microenvironments could be mitigated, and potentially exploited for benefit, through re-appropriating spaces within the building. Categories of use can be defined as, for example, working at a computer, working on a manual assembly task, the installation of printing equipment, meeting rooms, or coffee stations. Each use can then be assigned a range of suitable environmental conditions, as well as a volume requirement for a unit area assigned to that use. The digital twin may contain information about volumes within the building, and the corresponding environmental conditions. Additional constraints can be included, such as a requirement not to move large equipment more than a specified distance. An optimization algorithm, such as a genetic algorithm, can be applied to identify a desirable (e.g., optimal or new building equipment configurations to reach a set of environmental values) configuration of use within the building, without expensive retrofitting. Some embodiments could incorporate comfort preferences and space requirements on an individual basis. For example, individuals that prefer warmer temperatures could be assigned to naturally warmer areas of the building, and executive staff with larger space requirements could also be included in the optimization constraints.

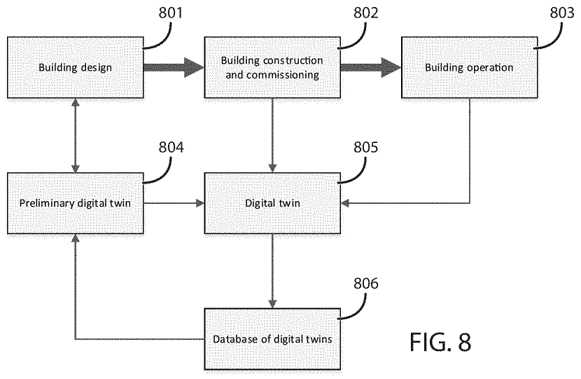

Referring now to FIG. 8, a flow diagram illustrating how a digital twin can be used throughout the lifecycle of a building is shown, according to some embodiments. The components represented in the flow diagram may represent steps performed by the BMS controller 12 or any other processor associated with the BMS (e.g., remote systems 444 or client devices 448). During a design phase 801, a digital representation of the building may be created 804, which includes simulations of equipment and the dynamics of the building. During a construction and commissioning of the building phase 802, as sensors and controls are installed, a digital twin 805 can begin to ingest real-world data and to provide feedback on the performance of the building. When the building is occupied in an occupied phase 803, the digital twin can continue to be updated with live data including sensor data and/or user feedback, and the added complexities of human presence and changing usage can be incorporated into the models to provide more accurate monitoring and predictions. The digital twin can also be used to identify inefficiencies in the building's systems, for example, caused by worn parts or incorrect installation. The digital twin can also be used to identify situations when the services within the building do not comply with regulations or standards, and alert an individual, such as a facilities manager, to take action or transmit a signal to a controller to cause the controller to automatically adjust the configurations of building equipment to correct the inefficiencies.

The data gathered from one or more digital twins can be used to improve the design of other buildings, and to create more accurate simulations. In some embodiments, data related to the digital twin is stored in a database along with data relating to other digital twins 806. A system can identify similarities between the design of a building and existing digital twins, such as choice of materials, volume, intended usage, orientation, and location. The system can compare corresponding aspects of the design of the building and designs of the existing digital twins and generate a similarity score for the individual designs. The system can compare the similarity scores to a threshold and/or to each other. Responsive to identifying a similarity score that exceeds the threshold and/or that is the highest, the system can identify the digital twin that corresponds to the identified similarity score. The system can generate a digital twin for the building that matches the identified digital twin using the same models that are used to generate the existing digital twin.

For example, in some embodiments, the system selects the digital twin from the database of digital twins 806 that is most similar to the current design 801, and then creates a copy of that selected digital twin to be the initial representation of the new digital twin 804. The system may make copies of the models that were used to generate the selected digital twin to create the copy of the selected twin. In some embodiments, the system selects two or more digital twins from the database of digital twins 806 that are most similar to the current design 801. The system then combines the computer models from the selected digital twins into a new digital twin 804 that represents the current design.

In some embodiments, each digital twin in the database of digital twins 806 is divided into component parts or subspaces, such as individual rooms. The system may generate digital twins may for individual component parts, in some cases using the sensor array, similar to how the system generated the digital twin for the entire building as described herein. For example, the system may similarly divide the building design 801 into component parts. The system may then create a new digital twin 804 by identifying component parts in the database of digital twins that are similar to component parts in the building design.

In some embodiments, processes are executed on the database of digital twins 806 to subdivide a digital twin into discrete component parts, to combine similar digital twins or component parts into a single representation, to assign metadata to digital twins or component parts, or to perform other operations that facilitate easier reuse. In some embodiments, such processes may be executed by assigning previously trained machine learning models to the different component parts, training new machine learning models based on data from the components, etc. The processes may also be executed by assigning data to the respective components.

In some embodiments, the digital twin 804 of a building at the design phase 801 maintains a dynamic link with the database of digital twins 806 (e.g., a digital pointer to the database of digital twins 806), such that as the design of the building is modified, the database of digital twins is automatically queried to retrieve components that correspond to the design of the building. In some embodiments, a user initiates the process to create a digital twin of the building 804. Such refinements may be or include updates or training to the models that the data processing system uses to generate the

[symbol]

In some embodiments, the digital twins 805 that represent real-world buildings 802 maintain a dynamic link with the database of digital twins 806, and in turn maintain a dynamic link with any preliminary digital twins 804 that are derived from the database of digital twins. When a digital twin that represents a real-world building is refined by the supply of real-world sensor data, the refinements are automatically transferred through to any associated preliminary digital twins. Such refinements may be updates to statistical or machine learning models that are used to generate the respective digital twin. The updates may include the addition of new data to the models and/or training the models based on the sensor data.

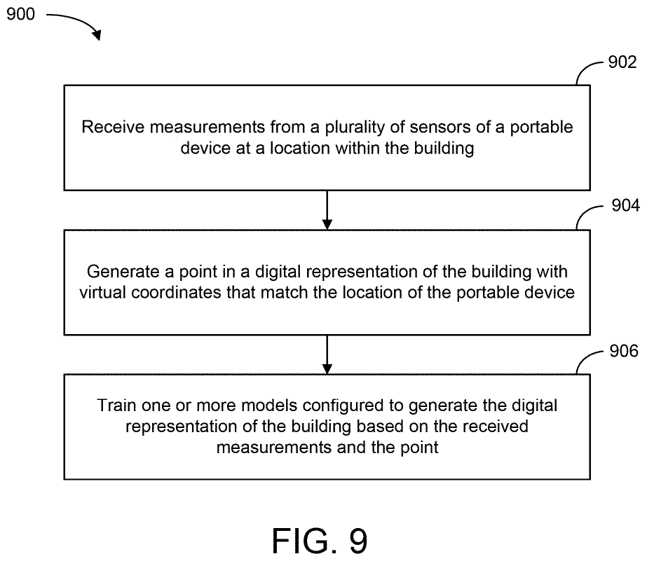

Referring now to FIG. 9, a flow diagram of a process 900 for updating a digital representation of a building is shown, according to some embodiments. Process 900 may be performed by a data processing system (e.g., BMS controller 12 or any other data processing system). Process 900 may include any number of steps and the steps may be performed in any order. At a step 902, the data processing system may receive measurements from a plurality of sensors of a portable device at a location within the building. The measurements may be associated with a time in which the data was collected. For example, the measurements may include data was collected from the plurality of sensors within a specific time period or interval of each other. The portable device may be or include a sensor array attached to a housing with sensors that are configured to collect data about the environment in which the portable device is located (e.g., temperature humidity, airflow, particulates, carbon dioxide, volatile organic compounds, light temperature, light intensity, and/or sound). The sensor array may be connected to the Internet or another network and transmit the collected sensor data to the data processing system, in some cases with timestamps indicating when the data was collected and/or transmitted.

The portable device may be associated with its location within the building within the data processing system. For example, upon being set, a user may input the portable device's coordinates within the building into a user interface for storage. In another example, the portable device may automatically detect its location based on detected signals from other similar portable devices (e.g., using distance triangulation). In another example, the location of the portable device may be predicted and/or recommended by one or more machine learning models that are trained to predict locations in which additional data is needed where there is not enough data to generate an accurate representation of the area within a model (e.g., an amount of data associated with the location does not exceed a threshold).

At a step 904, the data processing system may generate a point in a digital representation of the building with virtual coordinates that match the location of the portable device. The digital representation of the building may be a “digital twin” of the building as described above. The data processing system may generate the digital twin using one or more machine learning and/or statistical models that are configured to monitor the environmental conditions (e.g., various points in the building) and produce predictions indicating the comfortability of the environment, identify issues that may be causing the building occupants any discomfort, predict discomfort events (e.g., before such discomfort occur or are acknowledged by an occupant or administrator), and/or predict new building configurations for building equipment of the building to improve the comfortability of the environment. In some embodiments, the machine learning models may be configured to predict environmental conditions given the current configuration of the building equipment within the building and/or other factors (e.g., occupancy, sunlight, time of day, day of the week, etc.).

The data processing system may generate points within the digital twin that correspond to virtual coordinates. The virtual coordinates may be a virtual representation of physical coordinates within the physical building that corresponds to the digital twin. Such points and the corresponding virtual coordinates may be associated with a row in a table or a data file stored within the data processing system. The points may be associated with timeseries environmental data indicating data points that are collected by sensors at or that correspond to the physical location. Individual points may be associated with any amount of timeseries data and data about any environmental attribute or factor. Such data may be fed into the machine learning models that generate or make predictions about the digital twin for training and/or to make predictions.

The data processing system may generate a point in the digital twin that corresponds to the physical location of the portable device. For example, the data processing system may identify the location (e.g., physical coordinates) of the portable device within the building and generate a point with corresponding virtual coordinates within the digital twin with a tag or label indicating the portable device is located at the virtual coordinates (e.g., a device identifier). Consequently, the data processing system may correlate any data that the portable device collects (and any other sensor that is labeled or tagged with the point) with the generated point.

At a step 906, the data processing system may train one or more models configured to generate the digital representation of the building. The data processing system may do so based on the received measurements and the corresponding point associated with the location of the portable device. The one or more models may include one or more machine learning models (e.g., a neural network, random forest, support vector machine, etc.) configured to make predictions about the digital twin. The models may be configured to receive the data collected by the portable device and any other devices or sensors associated with the location of the portable device and use the data to label training data including the current configuration of the building equipment and/or the other factors as described above. In some embodiments, the label may include or correspond to the virtual coordinates of the portable device. The labeled training data may be fed into the machine learning model for supervised training to train the models to predict environmental factors that will be present in the building in unseen or seen conditions of the building.

Advantageously, because the labeled training data may correspond to individual locations in the building, the machine learning models may inherently be trained to take the physical layout and environment of the building into account when predicting the environmental conditions. For example, sunlight may impact different locations on a room differently depending on the location of the windows in the room or objects that may obstruct the sunlight from different locations. Because the training data may correspond to timeseries data at particular locations over time, the machine learning models may make predictions based on timeseries data that was generated in which the sunlight had an effect.

Furthermore, because the device is portable, the device may be moved to different locations and produce timeseries data for different locations within the building. Such data may be used to train the machine learning models to accurately predict environmental conditions throughout the building for individual areas instead of just providing a general overview of the conditions within the building or the conditions of the point when generating the digital twin.

Moreover, collecting the data for particular points in a building may enable the machine learning models to generate predictions for individual rooms or subspaces with a building to create virtual twins for the individual rooms. The points may be tagged with the rooms or subspaces in which they are located so any data provided by the portable device or sensors associated with the room (e.g., that collected about the room) may be tagged accordingly. One or more machine learning models may be individually trained to make predictions for the room or subspace, providing a more drilled view of the area in the corresponding digital twin.

In some embodiments, the one or more machine learning models may be trained to predict comfortability levels of the environment. The models may collect data about the environment at a point within the building. The data processing system may receive a user input indicating a level of comfort the user is experiencing within the building and/or at the point. The data processing may associate the feedback with the point responsive to receiving the input from a user interface of the portable device or responsive to the user feedback indicating the point or the location of the user within the building as being close to the point. Such feedback may include the level of comfort of the user (e.g., a level of comfort on a numbered scale or from a dropdown list). The data processing system may correlate the collected environmental data with the feedback responsive to determining that the user provided the feedback within a time interval (e.g., a predetermined time interval or threshold) of the timestamps associated with the data. The data processing system may accordingly tag the environmental data with the feedback and feed the data into the one or more models to train the models to predict comfortability levels based on environmental data.

In one example, the training data may be tagged with indications that a user was uncomfortable in the environment (e.g., experiencing a discomfort event). The data processing system may tag such data upon identifying a received comfortability score below a threshold or a selected comfort level associated with a discomfort event. The data processing system may tag the training data indicating the environment conditions are associated with the discomfort event for training.

Consequently, the machine learning models may be trained to predict discomfort events based on environmental data in cases when users do not provide feedback indicating the discomfort event or upon predicting environment condition based on the configurations of the building equipment and other factors. Such predictions can be made based on the current conditions and/or configurations of the building and/or scheduled or predicted conditions and/or configurations of the building. In such cases, the data processing system may transmit an alert to a computing device indicating the discomfort event or automatically adjust the configurations of the building equipment to improve the comfortability of the physical building (e.g., adjust configurations based on a predicted output from the machine learning models).

Systems not utilizing the methods described herein may have to wait to receive an indication that the area is uncomfortable before making any changes to the environment or the building equipment that manages the environment.

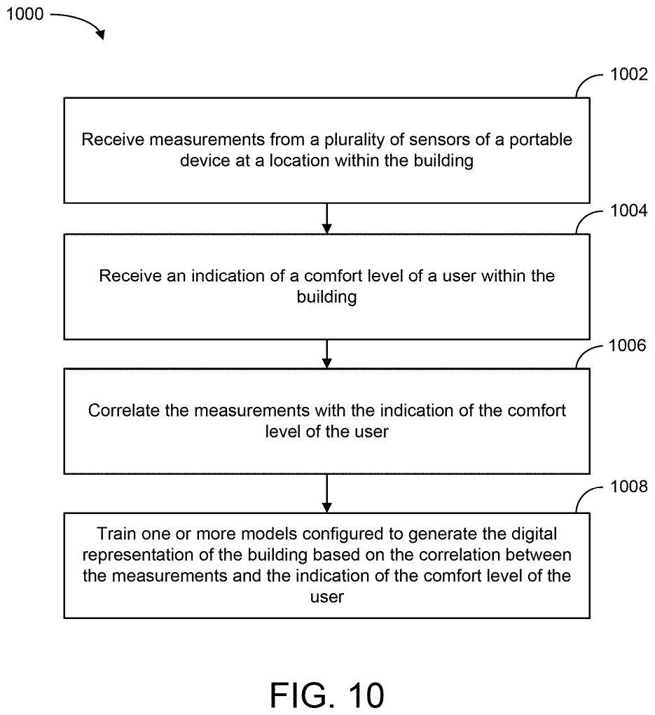

Referring now to FIG. 10, a flow diagram of a process 1000 for analyzing environmental data of a building is shown, according to some embodiments. Process 1002 may be performed by a data processing system (e.g., BMS controller 12 or any other data processing system). Process 1000 may include any number of steps and the steps may be performed in any order. At a step 1002, the data processing system may receive measurements from a plurality of sensors of a portable device at a location within the building. The measurements may include values of a plurality of environmental conditions at the location of the portable device within the building at a first time. Step 1002 may be performed similar to the process described with reference to step 902 of FIG. 9. At a step 1004, the data processing system may receive an indication of a comfort level of a user within the building. Step 1004 may be performed similar to the process described with reference to step 906 of FIG. 9. For example, the data processing system may receive an indication of the comfort level from the portable device itself or from a computer or other processor. The indication may be a value on a numbered scale, selected from a drop down, or manually typed in by the user. The user may indicate his or her location when experiencing the level of comfort or the data processing system may determine the location based on the stored location of the portable device.

At a step 1006, the data processing system may correlate the measurements with the indication of the comfort level of the user. The data processing system may do so responsive determining the measurements are associated with timestamps that are within a time interval or threshold of the time that the user provided the feedback or indicated that the feedback is associated with. The data processing system may compare the timestamps of the feedback with the timestamps of the measurements and/or the time interval or threshold to determine whether to correlate the feedback with the measurements. Responsive to determining the feedback was within the time interval or threshold of the measurements, the data processing system may generate a training data set comprising the feedback and the measurements.

In some embodiments, the user feedback may include a list of environmental factors that the user indicates are the cause of his or her level of comfort. For example, the user feedback may indicate that the user was uncomfortable because it was too hot, stuffy, cold, bright, isolated, dark, or any other factor that may affect the user's comfort. The user feedback may additionally or instead include indications of why the user was comfortable (e.g., comfortable temperature, good lighting, etc.). The list may include indications of whether the factors were positive or negative to better train the one or more models.

Further, in some embodiments, the training data may include productivity associated with one or more users that occupy the environment. For example, the data processing system may cross-reference key performance indicators (e.g., productivity levels, occupancy, participation, etc.) or other productivity metrics with the measurements based on timestamps that correspond to the indicators and the measurements. The data processing system may identify the productivity of the user during a time within a time interval or threshold of the timestamp of the measurements. The data processing system may generate a training data set by labeling the environmental measurements with a productivity label indicating the productivity of the user in the environmental conditions of the building or at the point of the portable device and feed the labeled data into the one or more models for training to predict environmental conditions in which the user performs well. In some embodiments, the data processing system further labels the training data associated with the comfort level of the user to correlate the productivity data, the comfort level indication, and the measurements for training.

At a step 1008, the data processing system may train one or more models configured to generate the digital representation of the building. The data processing system may do so by inputting the generated training data into machine learning models that are configured to generate a virtual twin of the building by predicting comfortability and/or environmental predictions. The data processing system may feed the training data into the one or more models to obtain an output indicating environmental conditions for which the users are comfortable and/or perform well.

In some embodiments, the data processing system may adjust the configurations of building equipment that affect the environment according to an environmental condition output of the machine learning models. For example, the machine learning models may output an indication that the building is or will be uncomfortable for its occupants and/or that the current conditions will result in low performance. Such predictions may be made for a current level of comfort or productivity or for predictions for the future. The machine learning models may further predict building equipment configurations that are associated with high performance and/or comfortability based on the current condition of the building and other factors (time of day, day of the week, current amount of sunlight hitting various areas within the building, etc.). The data processing system may receive the predicted building equipment configurations and adjust the corresponding building equipment according to the predictions. Consequently, the data processing system can control the building equipment to improve the occupant's level of comfort (and productivity) before receiving any indications of their discomfort or before they are uncomfortable at all.

In an example embodiment, a method of updating a digital representation of a building includes receiving, by a processing circuit, a measurement from a plurality of sensors of a portable device, the measurement comprising a plurality of values of environmental conditions at a location within a building at a first time; generating, by the processing circuit, a point in the digital representation of the buildings that are components of a digital twin, the virtual coordinates of the point corresponding to the physical location of the portable device; and refining, by the processing circuit, the computer models in response to the additional data provided by the sensors of the portable device, the refined models providing greater accuracy in simulating the dynamics of the building and detecting anomalous conditions.

In some embodiments, the method further includes reusing, by the processing circuit, parts of the computer models that contribute to the digital twin to create a digital twin to represent a different building.

In another example embodiment, a method of analyzing environmental data of a building associated with a building management system, including: receiving, by the processing circuit, a timestamped environmental measurement from multiple sensors of a portable device, the environmental measurement representing multiple values for environmental conditions at a localized point within a building; receiving, by the processing circuit, a user's timestamped comfort level indication from a user in proximity to the portable device, the comfort level indication representing the user's overall level of comfort; receiving, by the processing circuit, a user's timestamped list of environmental factors that are contributing to the received comfort level, the list indicating whether the contribution is positive or negative; correlating, by the processing circuit, the environmental measurement with the comfort level indication and the list of factors contributing to that comfort level; comparing, by the processing circuit, the environmental measurement with the comfort level indication and the list of factors contributing to that comfort level; and determining, by the processing circuit, the environmental conditions that are comfortable for said user and the effect of individual contributing factors.

In some embodiments, the method further includes receiving, by the processing circuit, productivity data relating to said user from a database and correlating the productivity data with the timestamped environmental measurement data, comfort level indication, and list of contributing factors.

In some embodiments, the method further includes automatically adjusting, by the processing circuit, the environmental controls within a building in response to the timestamped environmental measurement data, comfort level indication, and list of contributing factors.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A method for updating a digital twin of a building, comprising:
receiving, by one or more processors, measurements from a plurality of sensors of a portable device at a location within the building, the measurements comprising values of a plurality of environmental conditions at the location of the portable device within the building at a first time;
generating, by the one or more processors, a point in the digital twin of the building, the point having virtual coordinates that correspond to the location of the portable device within the building; and
training, by the one or more processors, one or more models configured to generate the digital twin of the building based on the received measurements and the point in the digital twin of the building.

2. The method of claim 1, wherein the measurements are first measurements, the location is a first location, the point is a first point, and the values are first values, the method further comprising:
receiving, by the one or more processors, second measurements from the plurality of sensors of the portable device at a second location within the building, the second measurements comprising second values of the plurality of environmental conditions at the second location at a second time;
generating, by the one or more processors, a second point in the digital twin of the building, the second point having virtual coordinates that correspond to the second location of the portable device within the building; and
training, by the one or more processors, the one or more models based on the received second measurements and the second point.

3. The method of claim 1, wherein the building is a first building, the method further comprising generating, by the one or more processors, a digital representation of a second building using the one or more models.

4. The method of claim 1, wherein the building is a first building, the method further comprising:
comparing, by the one or more processors, a design of the first building with a plurality of designs of second buildings;
identifying, by the one or more processors, a design of a second building with a similarity score with the design of the first building that exceeds a threshold; and
responsive to identifying the design of the second building with a similarity score that exceeds the threshold, generating, by the one or more processors, a digital twin of the second building using the one or more models.

5. The method of claim 1, further comprising:
adding, by the one or more processors, a representation of a piece of building equipment to the digital twin of the building; and
predicting, by the one or more processors using the one or more models, environmental effects of the addition of the piece of building equipment to the building.

6. The method of claim 1, wherein the point is first point, the method further comprising:
generating, by the one or more processors, digital twins of subspaces within the building using the one or more models, wherein the location is within a subspace of the building;
generating, by the one or more processors, a second point in a digital twin of the subspace, the second point having virtual coordinates that correspond to the location of the portable device within the subspace; and
training, by the one or more processors, the one or more models based on the received measurements and the second point.

7. The method of claim 1, further comprising:
predicting, by the one or more processors using the one or more models, whether the environmental conditions are likely to cause patient discomfort.

8. The method of claim 1, further comprising:
receiving, by the one or more processors, data from sensors associated with heating, ventilation, and air conditioning system of the building at the first time; and
training, by the one or more processors, the one or more models based on the received data.

9. The method of claim 1, further comprising:
training, by the one or more processors, the one or more models according to a supervised learning algorithm based on user feedback received within a time interval of the first time.

10. A system for updating a digital representation of a building comprising one or more memory devices configured to store instructions thereon that, when executed by one or more processors, cause the one or more processors to:
receive measurements from a plurality of sensors of a portable device at a location within the building, the measurements comprising values of a plurality of environmental conditions at the location of the portable device within the building at a first time;
generate a point in the digital twin of the building, the point having virtual coordinates that correspond to the location of the portable device within the building; and
train one or more models configured to generate the digital twin of the building based on the received measurements and the point in the digital twin of the building.

11. The system of claim 10, wherein the measurements are first measurements, the location is a first location, the point is a first point, and the values are first values, wherein the instructions further cause the one or more processors to:
receive second measurements from the plurality of sensors of the portable device at a second location within the building, the second measurements comprising second values of the plurality of environmental conditions at the second location at a second time;
generate a second point in the digital twin of the building, the second point having virtual coordinates that correspond to the second location of the portable device within the building; and
train the one or more models based on the received second measurements and the second point.

12. The system of claim 10, wherein the building is a first building, wherein the instructions further cause the one or more processors to generate a digital representation of a second building using the one or more models.

13. The system of claim 10, wherein the portable device comprises a housing and wherein the plurality of sensors are connected to the housing as a sensor array.

14. The system of claim 10, wherein the instructions further cause the one or more processors to:
add a representation of a piece of building equipment into the digital representation of the building; and
predict, using the one or more models, environmental effects of the addition of the piece of building equipment to the building.

15. The system of claim 10, wherein the instructions further cause the one or more processors to:
train the one or more models according to a supervised learning algorithm based on user feedback indicating a level of comfort of a user received within a time interval of the first time.

16. A method for analyzing environmental data of a building, comprising:
receiving, by one or more processors, measurements from a plurality of sensors of a portable device at a location within the building, the measurements comprising values of a plurality of environmental conditions at the location of the portable device within the building at a first time;
receiving, by the one or more processors, an indication of a comfort level of a user located within the building;
responsive to the indication of the comfort level being associated with a time within a time interval of the first time, correlating, by the one or more processors, the measurements with the indication of the comfort level of the user; and
training, by the one or more processors, one or more models configured to generate a digital representation of the building based on the correlation between the measurements and the indication of the comfort level of the user.

17. The method of claim 16, wherein the portable device is configured to receive the indication of the comfort level of the user via a user input on a display of the portable device.

18. The method of claim 16, further comprising:
receiving, by the one or more processors, a list of environmental factors that are associated with the received indication of the comfort level of the user, the list indicating whether the each factor of the list is positive or negative,
wherein training the one or models is further based on the list of environmental factors.

19. The method of claim 16, further comprising:
receiving, by the one or more processors, productivity data associated with the user; and
correlating, by the one or more processors, the productivity data with the measurement,
wherein training the one or models is further based on the correlated productivity data.

20. The method of claim 16, further comprising:
adjusting, by the one or more processors, the environmental controls within the building in response to receiving measurement data collected by the portable device at a second time based on an output by the trained one or more models.
